(19) United States
(12) Patent Application Publication
(10) Pub. No.: US 2014/0229364 A1
(43) Pub. Date: Aug. 14, 2014

(54) MORTGAGE COLLABORATIVE COMPLIANCE SYSTEM AND METHOD

(71) Applicant: Mortgage True View, Inc., Media, PA (US)

(72) Inventor: David K. Moffat, Media, PA (US)

(73) Assignee: Mortgage True View, Inc., Media, PA (US)

(21) Appl. No.: 14/176,539

(22) Filed: Feb. 10, 2014

Related U.S. Application Data
(60) Provisional application No. 61/764,276, filed on Feb. 13, 2013.

(51) Int. Cl. G06Q 40/02

(52) U.S. Cl. CPC G06Q 40/025
USPC 705/38

(57) ABSTRACT

A mortgage system including a first module configured to support operating and compliance metrics, a data store configured to store a set of key performance indicators in the mortgage field, a second module configured for data validation and related visualization protocols, and a multi-tier user access authorization module configured to allow data contributors (e.g., mortgage companies) to provide information to clients, auditors, regulators, and/or authorized third parties. A method includes providing a standard set of key performance indicators in the mortgage field to a group of data contributors, receiving data from the group of data contributors, determining one or more performance metrics over a period of time on an absolute basis, determining one or more performance metrics either at a point in time or for a period of time on a relative basis, and displaying a comparison of the one or more determined performance metrics.

### RELATED APPLICATION

This application claims priority to, and the benefit of co-pending U.S. Provisional Application No. 61/764,276, filed Feb. 13, 2013, for all subject matter common to both applications. The disclosure of said provisional application is hereby incorporated by reference in its entirety.

### FIELD OF THE INVENTION

The present invention relates to mortgage origination and servicing tools suitable for identifying and responding to compliance and regulatory rules, and more particularly to a mortgage origination and servicing system that can identify and reduce compliance and regulatory risks based on benchmarking.

### BACKGROUND OF THE INVENTION

Mortgage origination and servicing companies often experience difficulty dealing with the complexity of governmental rules and regulations, forcing the mortgage industry to revamp and overhaul their operations frequently. To aide in this process, software solutions have been implemented to guide mortgage companies (i.e., origination and servicing companies—mortgage originators and mortgage servicers) with respect to these rules/regulations.

A “mortgage originator” is a company or individual that is the original mortgage lender. “Mortgage servicers” are companies to which borrowers pay their mortgage loan payments and can perform other services related to mortgages and mortgage-backed securities. The mortgage servicer may or may not be the original mortgage lender. Regulators and agencies (e.g., Consumer Financial Protection Bureau) have the authority and responsibility to oversee mortgage servicers and improve accountability and transparency. The mortgage originators are also under pressure from regulators while dealing with other pressures such as interest rate fluctuations and complex economic factors of buyers. Thus, ensuring growth and profitability while maintaining high compliance standards has become increasingly difficult for mortgage companies.

There are mortgage industry management information systems that include governance, risk, and compliance solutions but do not provide sufficient data visibility. As a result, it is difficult to assess the completeness and accuracy of data. Mortgage industry management information systems or any other mortgage industry compliance and risk management technology has been typically enterprise-centric, while lacking benchmarking capabilities. The lack of benchmarking has limited the usefulness of known mortgage industry management information systems. Mortgage industry compliance and risk management technology has generally not considered business processes or enterprise profitability with respect to the mortgage industry.

### SUMMARY

There is a need for mortgage software technology to provide aid with mortgage industry compliance and regulatory pressures and processes. There is a further need for mortgage software technology to provide data contributors (e.g., mortgage companies) with the opportunity to review data that correlates with successes or failures dealing with rules/regulations. More particularly, there is a need for software technology that allows mortgage companies to contribute to, and draw from, a shared library of user-defined metrics for enhanced comparative analytics (i.e., benchmark against other companies).

The present invention provides a data contributor (e.g., mortgage company) with visualization into the completeness and validation of data received by mortgage companies. The present invention provides mortgage companies with the opportunity to share data amongst themselves as well as with approved third-parties such as a regulator or client. The present invention provides mortgage companies and other interested third-parties with integrated loan-level governance, risk management, compliance, and business process metrics (i.e., platform attributes). These platform attributes provide the basis for two key aspects of the present invention: collaborative benchmarking metrics and business process intelligence metrics (i.e., indicators). Collaborative benchmarking metrics provide mortgage companies with insight into their relative governance, compliance, and risk profiles. Business process intelligence metrics indicate whether or not outcomes are a result of conformity with established operating policies and procedures. The present invention is directed toward further solutions to address these needs, in addition to having other desirable characteristics.

In accordance with an embodiment of the present invention, a method includes, in one or more computing systems, providing a standard set of key performance indicators in the mortgage field to a group of data contributors. Data is received from the group of data contributors. One or more performance metrics are determined over a period of time on an absolute basis. The absolute basis includes comparing data from one data contributor of the group of data contributors with its own data, and/or to stipulated standards in such a way that an absolute difference is determined based on at least one of the key performance indicators. One or more performance metrics are determined either at a point in time or for a period of time on a relative basis. The relative basis includes comparing a set of data of the group of data contributors against a different set of data from a different group of data contributors on an anonymous and transparent basis in such a way that a relative difference is determined based on at least one of the key performance indicators. A comparison of the one or more performance metrics determined on the absolute basis and/or the relative basis is stored and displayed.

In accordance with aspects of the present invention, determining one or more performance metrics on the relative basis includes benchmarking data from the group of data contributors with the different set of data from the different group of data contributors to generate benchmark data. Actions and activities by the group of data contributors are identified based on the generated benchmark data. The benchmark data includes both standard mathematical and statistical summaries and user-configurable metrics and analytics based on a body of contributed data elements.

In accordance with one aspect of the present invention, the data received from the group of data contributors is validated prior to determining one or more performance metrics.

In accordance with aspects of the present invention, displaying the comparison of the one or more determined performance metrics includes a comparison based on compliance indicators. In one aspect, the comparison is based on business process indicators. In another aspect, the comparison is based on collaborative benchmarking. In one aspect, the comparison is based on secondary market and/or securitization. In another aspect, the comparison is based on governance, risk, and compliance (“GRC”) protocols.

In accordance with an embodiment of the present invention, a computer implemented mortgage system includes a first module configured to support operating and compliance metrics. The mortgage system includes a data store configured to store a set of key performance indicators in the mortgage field related to rules and regulations by regulators and third parties. The mortgage system includes a second module configured for data validation and related visualization protocols. The second module provides assurance that a plurality of contributed data is valid and usable within the system. The mortgage system includes a multi-tier user access authorization module configured to allow a plurality of data contributors of the plurality of contributed data to provide information to clients, auditors, regulators, and/or authorized third parties.

In accordance with one aspect of the present invention, the mortgage system includes a third module configured to develop, test, maintain, and manage regulatory taxonomies based on both rules and regulations issued by government agencies and a group consensus. In another aspect, the mortgage system includes a third module configured to incorporate data from one or more data contributors of the plurality of data contributors and subject-matter experts.

In accordance with aspects of the present invention, the first module is configured to determine one or more performance metrics on an absolute basis and/or relative basis based on the plurality of contributed data. In one aspect, the first module is configured to benchmark the plurality of contributed data from the plurality of data contributors with a different set of contributed data from a different plurality of data contributors to generate benchmark data. The first module is configured to identify actions and activities by the plurality of data contributors based on the generated benchmark data. In one aspect, the generated benchmark data includes both standard mathematical and statistical summaries and user-configurable metrics and analytics based on a body of contributed data elements.

In accordance with aspects of the present invention, a display module is configured to display a comparison of one or more performance metrics. The display of the comparison of the one or more performance metrics includes a comparison based on compliance indicators and/or business process indicators. In one aspect, the comparison is based on collaborative benchmarking. In another aspect, the comparison is based on secondary market and/or securitization. In one aspect, the comparison is based on governance, risk, and compliance (“GRC”) protocols.

### BRIEF DESCRIPTION OF THE FIGURES

These and other characteristics of the present invention will be more fully understood by reference to the following detailed description in conjunction with the attached drawings, in which:

FIG. 1 is a schematic illustration of a mortgage system, according to an embodiment of the present invention;

FIG. 2 is a flow chart illustration of a method for using the mortgage system of FIG. 1, according to an embodiment of the present invention;

FIG. 3 is a schematic illustration of data flow to the mortgage system and use of dashboards by the mortgage system, according to one aspect of the present invention;

FIGS. 4A-4M are example computer displays illustrating menu options providing various features, according to aspects of the present invention;

FIGS. 5A-5B are example computer displays illustrating data contributors (e.g., mortgage companies) uploading data to the mortgage system, according to aspects of the present invention;

FIGS. 6A-6B are example computer displays illustrating visual data validation, according to aspects of the present invention;

FIG. 7 is an example computer display illustrating performance of a data contributor (e.g., mortgage company) compared to other data contributors (e.g., mortgage companies), according to one aspect of the present invention;

FIG. 8 is an example computer display illustrating a scatter plot of performance, according to one aspect of the present invention;

FIGS. 9A-9B are computer displays illustrating benchmarking graphs, according to aspects of the present invention;

FIGS. 10A-10F are example computer displays of other types of graphs or plots, according to aspects of the present invention; and

FIG. 11 is a schematic view of a computing device or system, suitable for implementing the systems and methods of the present invention.

### DETAILED DESCRIPTION

An illustrative embodiment of the present invention relates to a mortgage collaborative compliance system and method (herein after “mortgage system”) for providing compliance and regulatory risk guidance to data contributors (e.g., mortgage companies). The mortgage system can include a first module that supports operating and compliance metrics related to mortgages. A data store can be included for storing key performance indicators related to rules and regulations in the mortgage field. The mortgage system can include a second module that provides data validation and related visualization protocols. The data validation provides assurance that contributed data is valid and usable within the mortgage system. The mortgage system can include a multi-tier user access authorization module that enables mortgage companies to share information from the mortgage system with clients, auditors, regulators, and/or authorized third parties. Use of the mortgage system can include determining performance metrics on an absolute basis and/or a relative basis. The mortgage system can display a comparison of the determined performance metrics.

The mortgage system enables data contributors such as mortgage companies (e.g., originators or servicers) to decrease their risks related to compliance and regulatory issues through increased knowledge of how various mortgage rules are applied. In particular, the determination of performance metrics (absolute basis or relative basis) allows for mortgage companies to visualize resulting data from application of mortgage rules and regulations. The relative basis feature provides collaborative benchmarking allowing mortgage companies to compare mortgage data against one another to determine their own strengths and weaknesses. This benchmarking feature is utilized anonymously such that the private mortgage data is not compromised between companies or other parties using the mortgage system. The mortgage system further provides key performance indicators such that mortgage companies can focus on improving or changing actions in particular areas of weakness and maintain standards in areas of strength. Through validation, the mortgage system can determine whether uploaded data is valid and usable prior to analysis.

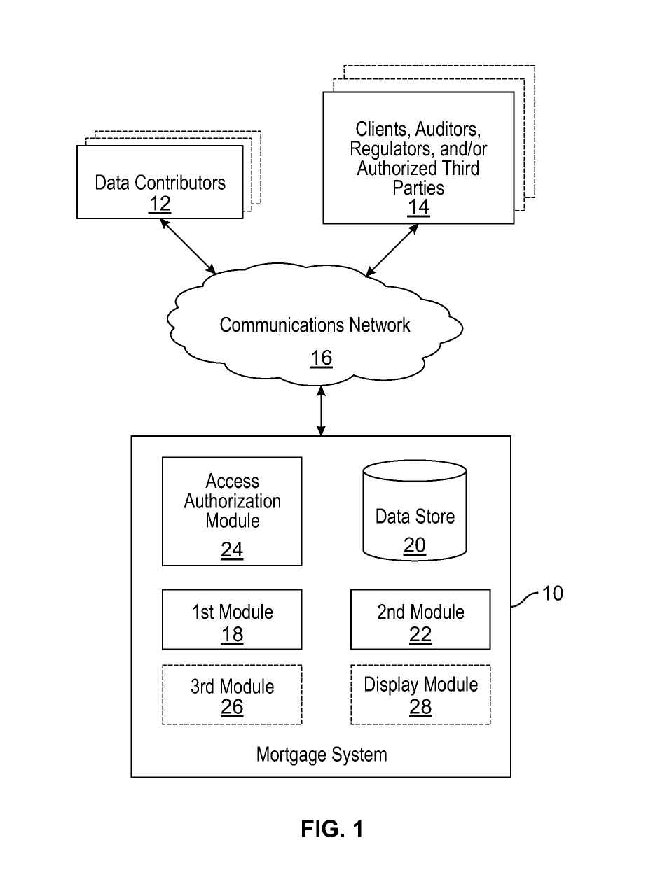

FIGS. 1 through 11, wherein like parts are designated by like reference numerals throughout, illustrate the mortgage system according to the present invention. Although the present invention will be described with reference to the figures, it should be understood that many alternative forms can embody the present invention. One of skill in the art will additionally appreciate different ways to alter the parameters disclosed, in a manner still in keeping with the spirit and scope of the present invention.

The mortgage system is configured to identify and reduce compliance risks defined by various government regulations (e.g., federal/state banking) and to improve business process controls associated with loan servicing and offering. In one example, the mortgage system can be offered as a SAAS (software as a service) such that the mortgage system is a software application that is fully supported and implemented using controlled access portals within the Internet. Thus, a user such as a data contributor (e.g., mortgage company) can access the software via a mobile device or computer-based server and use end user tools such as dashboards, query and analysis, enterprise reporting, and disconnected access to data—all supported by unified, model-centric server architecture. The mortgage system can be incorporated in other software or system formats as would be appreciated by one of skill in the art.

The mortgage system is an operational and regulatory compliance system that is configured to respond to specific mortgage origination and servicing rules and regulations issued by third-parties (e.g., government agencies such as the Consumer Financial Protection Bureau). The mortgage system can be configured to support operating and compliance metrics. The mortgage system incorporates an expansive and extensive set of metrics (i.e., key performance indicators) based on the rules and regulations issued by regulators and other third-parties. For example, key performance indicators can include delinquency, documentation type, debt to income ratio (DTI), early payoffs, early payment defaults (EPD), FICO score, funding quality, geographic concentration, loan purpose type, loan to value (LTV), occupancy type, outstanding documents, production, property type, pull through, quality control (QC), repurchases & indemnities, servicing issues, cycle time, etc. One of skill in the art will appreciate other key performance indicators known within the mortgage field industry as being included in this list.

FIG. 1 depicts a mortgage system 10 that communicates with data contributors 12 (e.g., mortgage companies) and clients, auditors, regulators, and/or authorized third parties 14 via a communication network 16 (e.g., Internet) in accordance with an example embodiment of the present invention. The mortgage system 10 can be an operational and regulatory compliance system. The mortgage system 10 includes a first module 18 that supports operating and compliance metrics. The mortgage system 10 includes a data store 20 that stores a set of key performance indicators from the mortgage field. These key performance indicators can be related to rules and regulations by regulators and third parties. A second module 22, within the mortgage system 10, is configured for data validation and related visualization protocol. The second module 22 provides assurance that contributed data is valid and usable within the mortgage system 10. The mortgage system 10 includes a multi-tier user access authorization module 24 that enables data contributors 12 of the contributed data to provide information to clients, auditors, regulators, and/or authorized third parties.

In accordance with one example, the first module 18 determines one or more performance metrics on an absolute basis and/or relative basis. The first module 18 benchmarks contributed data with a different set of contributed data to generate benchmark data (i.e., relative basis). The first module 18 identifies actions and activities by the data contributors 12 based on the generated benchmark data. For example, actions or activities that impact performance can include processing delays, non-standard processing, incomplete applications, staffing attributes (e.g., efficiency ratios, turnover, etc.), competitive trends, and/or product attributes (e.g., pricing, down payment, etc.). In one example, the generated benchmark data includes both standard mathematical and statistical summaries (e.g., average, mean, mode, deviations, etc.) and user-configurable metrics and analytics (e.g., mortgage operating and compliance metrics) based on a body of contributed data elements

In one example, the mortgage system 10 has a third module 26 that develops, tests, maintains, and manages regulatory taxonomies based on rules and regulations issued by government agencies and group consensus. Alternatively, the third module 26 can incorporate data from data contributors 12 and subject-matter experts.

In one example, the mortgage system 10 has a display module 28 that is configured to display a comparison of one or more performance metrics on a computing device. For example, the display module 28 provides a display that includes a comparison based on compliance indicators, business process indicators, collaborative benchmarking, secondary market, securitization, and/or governance, risk, and compliance.

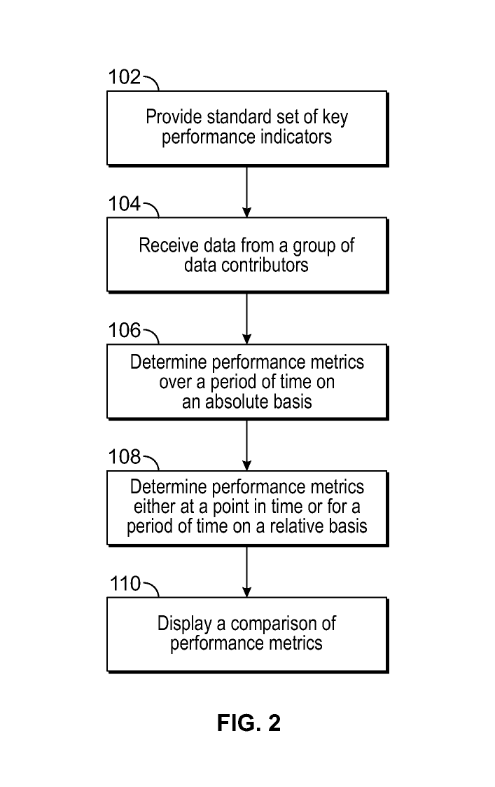

FIG. 2 depicts a flow chart displaying the computer implemented steps for utilizing the mortgage system 10. In step 102, a standard set of key performance indicators in the mortgage field is provided to a group of data contributors 12 (e.g., mortgage companies). Data from the group of data contributors 12 is received (step 104). In step 106, performance metrics are determined over a period of time on an absolute basis. “Absolute basis” can be defined as comparing data of a data contributor 12 to its own data over a period of time such that an absolute difference is determined. In particular, “absolute basis” provides the ability of the data contributor 12 to view their own metrics over a period of time. For example, “absolute basis” can mean comparing data of a data contributor 12 at a first point in time to data of the same data contributor 12 at a later or second point in time (i.e., over a period of time). This enables the data contributor 12 to determine certain performance metrics over a period of time to observe where specific performance improved, declined, or was maintained. Absolute basis can additionally or alternatively be defined as comparing data of the data contributor 12 to stipulated standards (e.g., industry standards or mortgage company standards). The absolute basis determination can be based on at least one key performance indicator. In step 108, performance metrics are determined either at a point in time or for a period of time on a relative basis. “Relative basis” can be defined as comparing data of the group of data contributors 12 against a different set of data from a different group of data contributors 12 on an anonymous and transparent basis such that a relative difference is determined based on at least one key performance indicator. In particular, “relative basis” provides the ability of the data contributor 12 to view their metrics compared to other data contributor metrics (i.e., benchmarks) at either a point in time or for a period of time. A comparison of determined performance metrics (whether absolute or relative) can be displayed (step 110) (e.g., using the display module 28). For example, performance metrics determined either by absolute basis or relative basis can be displayed or presented using a desired time dimension or period of time (e.g., rolling 12 months, current year, prior year, period-to-date (PTD), prior PTD, year-to-date (YTD), or prior YTD). In one example, the method can include a step of validating the data received from the data contributors 12 prior to determining performance metrics.

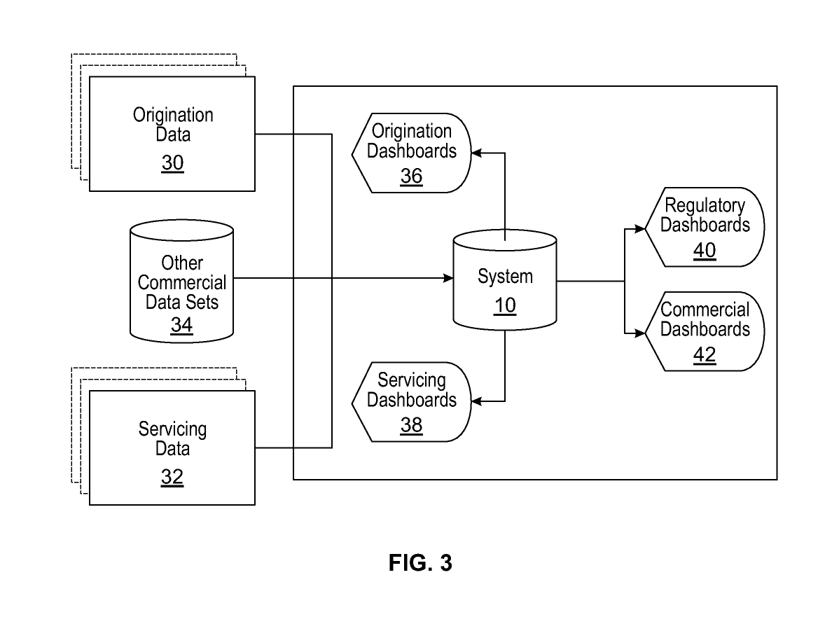

FIG. 3 depicts data flow to the mortgage system 10 and use of dashboards by the mortgage system 10. In particular, contributed data includes origination data 30 (from originating mortgage companies), servicing data 32 (from servicing mortgage companies), and other commercial data 34 (e.g., data sets sold by market data consolidators such as CoreLogic® as well as public domain data sets provided free of charge by the Federal Financial Institutions Examination Council (FFIEC), Census Bureau, etc.) that is uploaded to the mortgage system 10. The mortgage system 10 applies the origination data 30, servicing data 32, and/or other commercial data 34 with respect to different dashboards. In this example, the mortgage system 10 utilizes an origination dashboard 36, servicing dashboard 38, regulatory dashboard 40, and commercial dashboard 42 with respect to analyzing the received contributed data.

The functionalities of the mortgage system 10 can include: Visual Data Validation, Collaborative Benchmarking, and Business Process Intelligence. The visual data validation and business process intelligence leverages structured query language (SQL) capabilities. Visual Data Validation (i.e., Data Risk Visualization) can include data validation and completeness protocols. Collaborative Benchmarking particularly Compliance Benchmarking can include traditional statistical measures (e.g., average, mean, mode, deviations, etc.). Another functional component of the mortgage system 10 can include shared analytics. Shared analytics can facilitate the development and adoption of best practices for mortgage companies. For example, if one data contributor 12 is evaluating an item on the basis of attribute A and through shared analytics finds that all other data contributors 12 are evaluating the same item on the basis of attribute B, the data contributor 12 can bring their perspective in line with market practice. Shared analytics is a tool for driving standardization and reducing risk.

Visual Data Validation provides the basis for assuring that contributed data (i.e., source data) received by the mortgage system 10 is complete and accurate—at any point in time and for any period of time—based on stipulated content and edit checks. For example, visual data validation can include providing charts and dashboards to visually demonstrate the degree of completeness—and therefore reliability—of source data.

Collaborative Benchmarking provides each data contributor 12 (e.g., mortgage company) with empirical information as to how their governance, compliance, and risk profile compares—or benchmarks—to risk profiles of other data contributors 12 or mortgage companies. This benchmarking feature permits the mortgage companies to more efficiently and effectively manage a range of essential enterprise activities and to constructively engage with regulators (e.g., federal and state regulators).

Business Process Intelligence permits the mortgage companies to integrate production measures with governance, risk, and compliance activities to calibrate the relative effort and outcomes associated with such activities. For example, if default management activities include the obligation to perform a task at least 14 days prior to an event and business process intelligence metrics indicate that such task is completed 21 days prior to said event, the enterprise can adjust workloads—and thereby reduce costs—and remain in compliance with enterprise and/or regulatory standards. Business Intelligence (Be software within the mortgage system 10 can consolidate, analyze, and display an institution's loan servicing data collected or generated by a loan servicing application provider from both origination and servicing transactional business systems to provide visual insights. The visual based analytics can include predictive modeling and benchmarking.

With respect to data contributor 12 (e.g., mortgage company) benchmarking (e.g., origination and servicing benchmarking), important considerations can include: defining metrics sufficiently and appropriately, availability of data to prepare metrics, management of metric changes, reporting or staging of metrics, how and when new metrics are added, who receives the metrics and at what interval, how metrics are provided to recipients, how mortgage company's metrics are evaluated, and metrics being comparable from one mortgage company to another different mortgage company. The mortgage system 10 provides a standard set of key performance indicators to data contributors 12 (e.g., mortgage companies) to be utilized in benchmarking the contributed data of each mortgage company against data of other mortgage companies for the purpose of anonymous benchmarking. This facilitates a deeper understanding about each mortgage company's actions and activities.

The mortgage system 10 provides data contributors 12 (e.g., mortgage companies) with the ability to anonymously compare and evaluate their performance metrics against other data contributors 12 (e.g., mortgage companies). A mortgage company can evaluate their performance over a period of time against themselves and/or stipulated standards such as industry standards and/or mortgage company performance standards (i.e., absolute benchmarks or absolute basis). This absolute benchmark or absolute basis allows for the mortgage company to look at their progress over a period of time to determine where they have improved or declined (e.g., this can be compared to an internal goal for the mortgage company). Alternatively or additionally, a mortgage company can evaluate their performance against peers at a point in time or over a period of time (i.e., relative benchmarking, comparative benchmarking, or relative basis). This relative benchmarking or relative basis allows for the mortgage company to look at their progress with respect to other mortgage companies to determine where they have improved or declined. The relative benchmarking function can use data and related metrics in benchmark metrics to allow a user to visualize their relative performance (presented anonymously). This relative benchmarking information drives process improvement, regulatory engagement, and provides other considerations to data contributors 12. The overall benchmarking function (whether absolute benchmarking or relative benchmarking) can provide the following key features: regulatory risk management, financial risk management, and revenue risk management.

With respect to Regulatory Risk Management, the mortgage system 10 enables a data contributor 12 (e.g., mortgage company) to proactively address areas of both absolute and relative underperformance which reduces the risk of regulatory actions, including money penalties. Conversely, the mortgage system 10 allows a mortgage company to empirically demonstrate areas where their performance exceeds both absolute and relative standards which historically can be an important role in tempering the potential adverse consequences of underperformance in other areas. This feature is especially important as regulators are adjusting their approach to use Business Intelligence (BI) platforms in the acquisition and evaluation of massive data sets so that they can identify and manage risk. The mortgage system 10 can provide mortgage companies with the ability to effectively operate within such a regulatory paradigm.

With respect to Financial Risk Management, to the extent a mortgage company's performance exceeds a regulatory or proprietary performance standard, the mortgage system 10 can provide a level of intelligence that allows management to adjust (i.e. reduce or redirect) performance. For example, the mortgage system 10 can reduce/redirect by directing a mortgage company to enhance performance in other areas to lower costs and thus improve margins.

With respect to Revenue Risk Management Retention/Generation, the mortgage system 10 can provide information and intelligence to enhance revenue risk management activities. Specific features can include providing data contributors 12 (e.g., mortgage companies) with the intelligence to provide independent evaluation of compliance with Service Level Agreements and independent performance rankings to attract new business.

Other features of the mortgage system 10 can include collaborative risk management and taxonomy management (e.g., data trust and taxonomy). The mortgage system 10 can provide data contributors 12 (e.g., mortgage companies) with the opportunity to incorporate anonymously transparent benchmarking—also known as collaborative compliance—into their risk management protocols. In addition to providing the comprehensive and relevant insight into a mortgage company's absolute and relative performance, collaborative compliance allows mortgage companies to empirically demonstrate the management capabilities in identifying and addressing issues. The mortgage system's use of the collaborative risk management paradigm can provide industry-wide standardization of taxonomies including data sets, metric definitions, and performance standards. The mortgage system 10 can utilize data from a key performance indicators (KPI) Steering Committee—comprised of users, domain experts, and advocates—to enhance outcomes and lower compliance costs. The mortgage system 10 can provide taxonomy management that includes performance summaries for third-party stakeholders with performance standards such as research and development.

There are other features that can be included within the mortgage system as may be appreciated by those of skill in the art having the benefit of the present disclosure. For example, a secondary market/securitization function can be utilized. The secondary market/securitization function uses validated offering and post-offering data with various dashboards to demonstrate both absolute and relative attributes. For example, a Governance, Risk, and Compliance (“GRC”) function can be utilized which can include a GRC dashboard (e.g., utilizes GRC protocols) that presents origination and servicing metrics in a way that facilitates enterprise oversight by executives, risk management, and compliance executives and staff members.

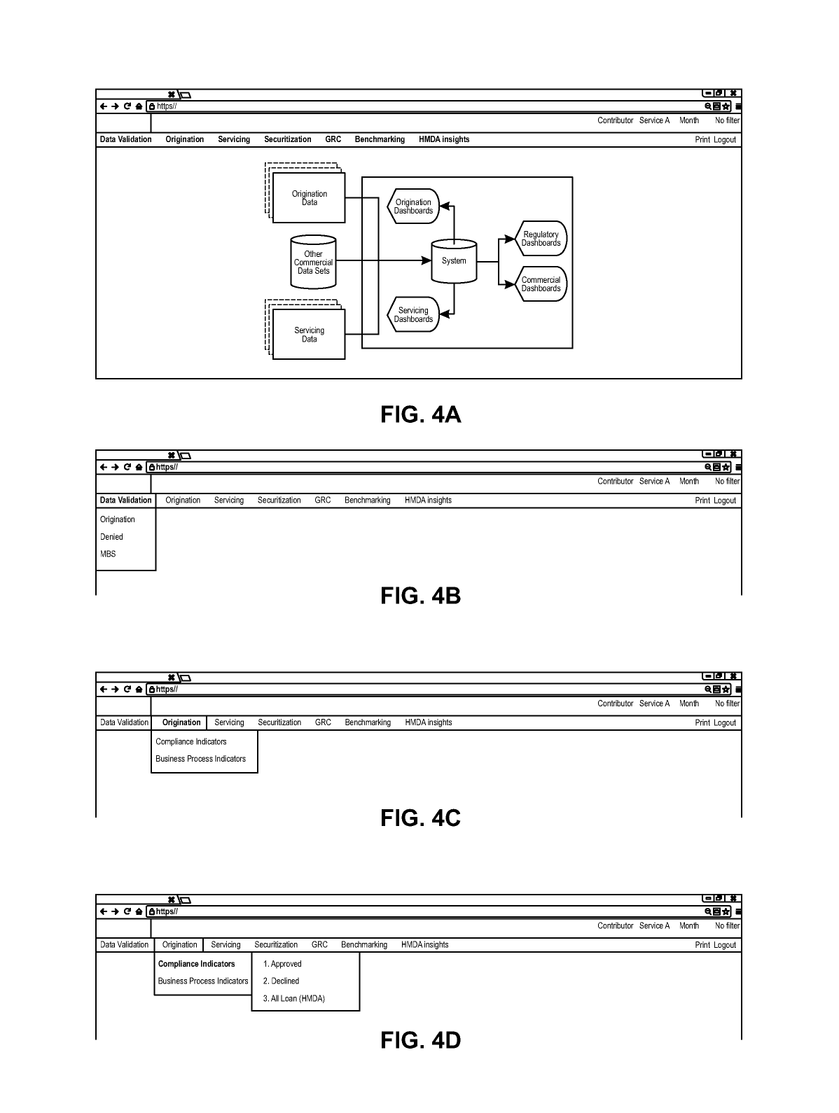

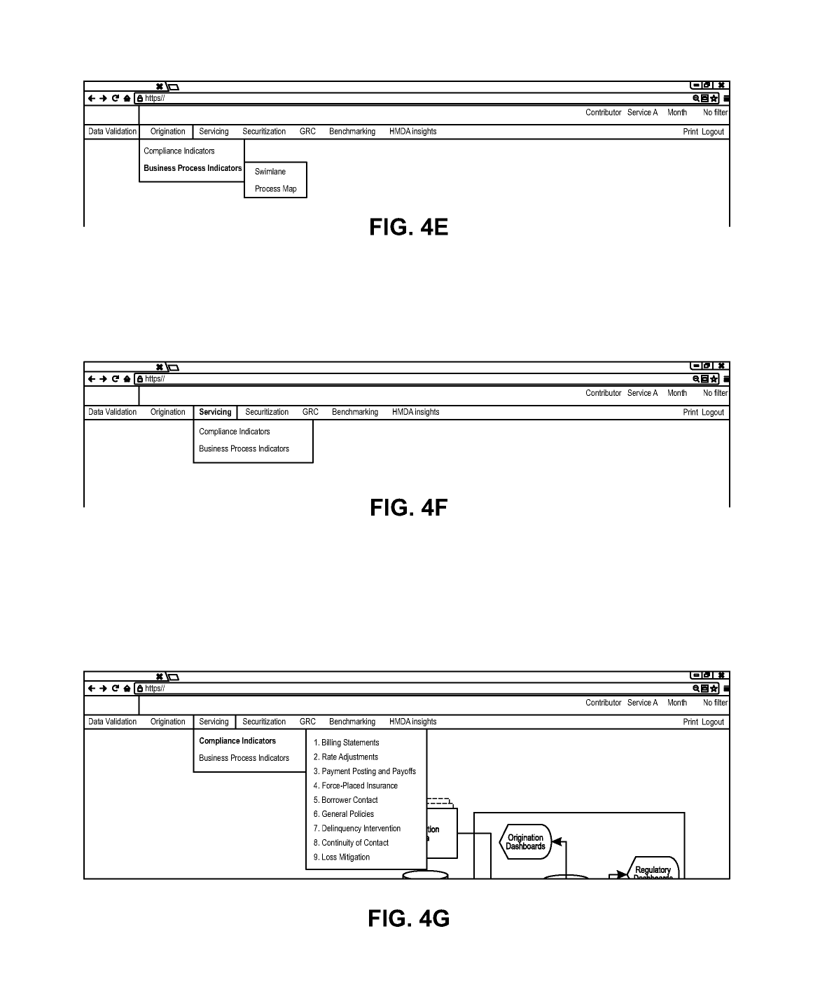

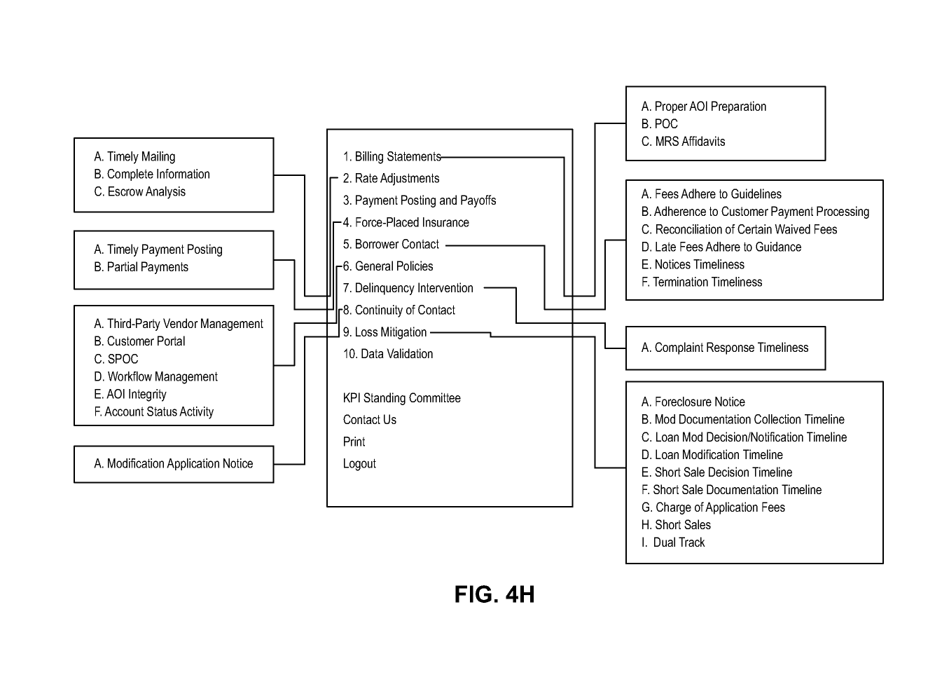

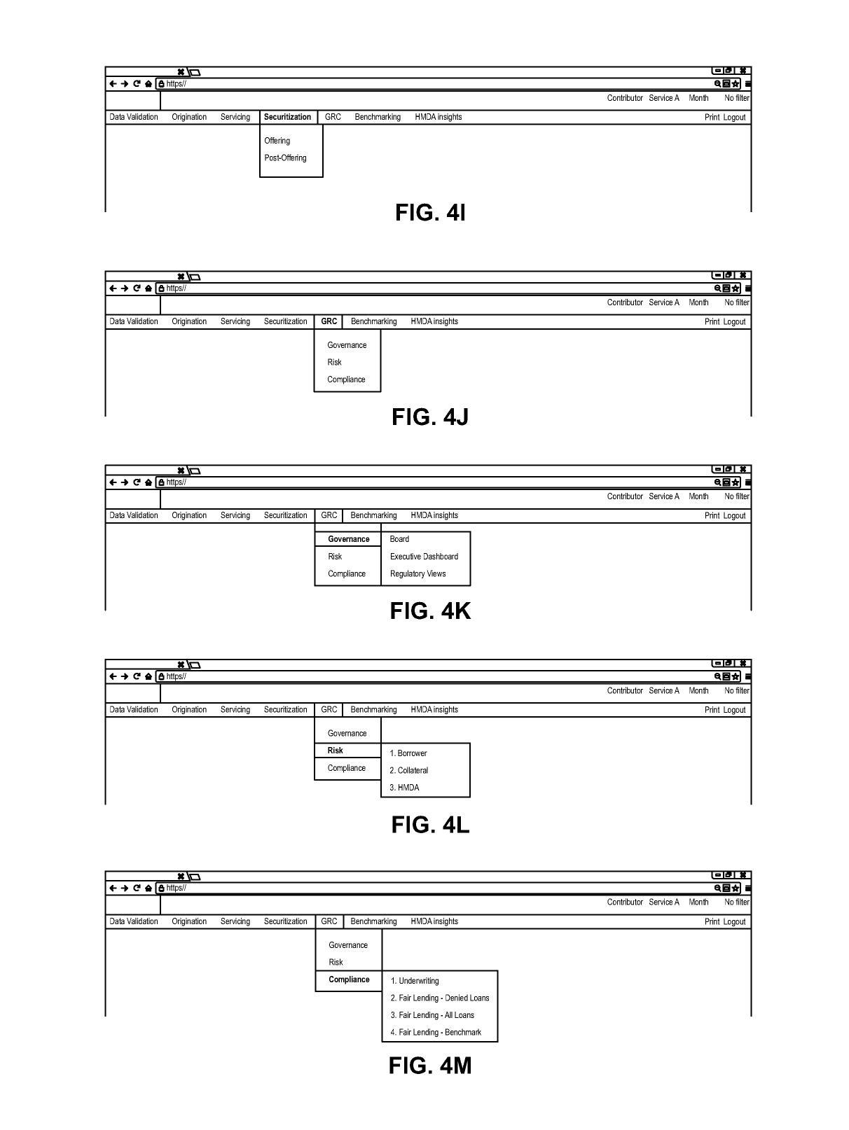

FIGS. 4A-4M depict the mortgage system 10 implemented as an example software driven process with various menu options or dashboards displayed to the user. In FIG. 4A, the main menu includes the following dashboard options: data validation, origination, servicing, securitization, Governance, Risk, and Compliance (“GRC”), benchmarking, and home mortgage disclosure act (HMDA) insights. The mortgage system 10 can be additionally used to access other products of affiliates or business partners through dashboard options in the main menu.

As shown in FIG. 3, data (i.e., specifically mortgage data) is acquired in a manner acceptable to the data contributor 12 (e.g., mortgage company). The mortgage system 10 can provide mortgage companies (e.g., originators and servicers) with a flexible, scalable, and secure Business Intelligence platform that can source data from a range of databases—including core platforms and spreadsheets—to provide a comprehensive view of key performance indicators that can confirm—or clarify—the contributed data used by regulators in their supervision and oversight activities. In addition, the mortgage system 10 can standardize contributed data which, in turn, drives fact-based, multi-dimensional benchmarking. This enables a mortgage company to more easily identify, prioritize, and achieve improvement opportunities.

Mortgage data is subjected to data validation protocols and the results are presented in one or more Data Validation dashboards that provide users with an interactive experience (using the menu options shown in FIG. 4B). For example, the data validation module can include the sub-modules of origination, denied, and mortgage-backed security (MBS). The contributed data (e.g., origination data or servicing data) is validated such that the validated data is presented in two constructs: Compliance Indicators and Business Process Indicators.

With compliance indicators, compliance indicator dashboards present a range of metrics configured to provide the user with the means to review, evaluate, and analyze loan applications that were approved—and those that were not approved—in terms of enterprise and regulatory standards and guidelines. Among other things, these dashboards can include multi-dimensional scatter charts and data tables. The compliance indicator dashboards can provide users with an interactive experience.

With business process indicators, business process indicator dashboards can present swim lane and process maps that display business process metrics demonstrating compliance with origination and underwriting protocols. The data contributor 12 (e.g., mortgage company) can drill down on process exceptions to more fully understand the nature of any exceptions and to identify appropriate remedial actions. These business process indicator dashboards provide mortgage companies with an interactive experience.

As shown in FIG. 4C, an example origination module can include the sub-modules of compliance indicators and business process indicators. In this example, the compliance indicators can include approved, declined, or all loans (HMDA) shown in FIG. 40. The business process indicators can include swim lanes and process maps as shown in FIG. 4E.

As shown in FIG. 4F, an example servicing module can include the sub-modules of compliance indicators and business process indicators. In this example, as shown in FIGS. 4G-4H, compliance indicators can include metrics of billing statements, rate adjustments, payment posting and payoffs, force-placed insurance, borrower contact, general policies, delinquency intervention, continuity of contact, and loss mitigation. FIG. 4H depicts a comprehensive set of metrics. These metrics can be based on rules and regulations issued by regulations and regulatory agencies (e.g., Consumer Financial Protection Bureau, Mortgage Settlement Guidelines, and industry standards). Metrics can be logically grouped by regulatory taxonomy. For example, regulatory taxonomies can include billing statements, rate adjustments, payments & payoffs, force-placed insurance, borrower contract, delinquency intervention, loss mitigation, etc. The metrics can be, for example with loss mitigation, foreclosure notice, loan modification timeline, change of application fees, short sales, etc. For example, with delinquency intervention, a metric can be complaint response timeline.

As shown in FIG. 4I, an example securitization module can include the sub-modules of offering and post-offering. A Governance, Risk, and Compliance (“GRC”) module can include the sub-modules of governance, risk, and compliance as shown in FIG. 4J. For governance, this can include dashboards such as board, executive dashboard, and regulatory views (shown in FIG. 4K). For risk, this can include metrics such as borrower, collateral, and HMDA (shown in FIG. 4L). For compliance, this can include metrics such as underwriting, fair lending—denied loans, fair lending—all loans, and fair lending—benchmark (shown in FIG. 4M). In this example, the mortgage system 10 can provide a detailed view for compliance specifically underwriting. Governance, Risk, and Compliance are a renewed focus for many mortgage companies and organizations. The penalties from failures in compliance are substantial such that they can potentially cripple an organization and hasten failure and bankruptcy. Corporate governance, enterprise risk management, and compliance with applicable laws and regulations can require enterprise-class tools to monitor, manage, and mitigate for effective GRC.

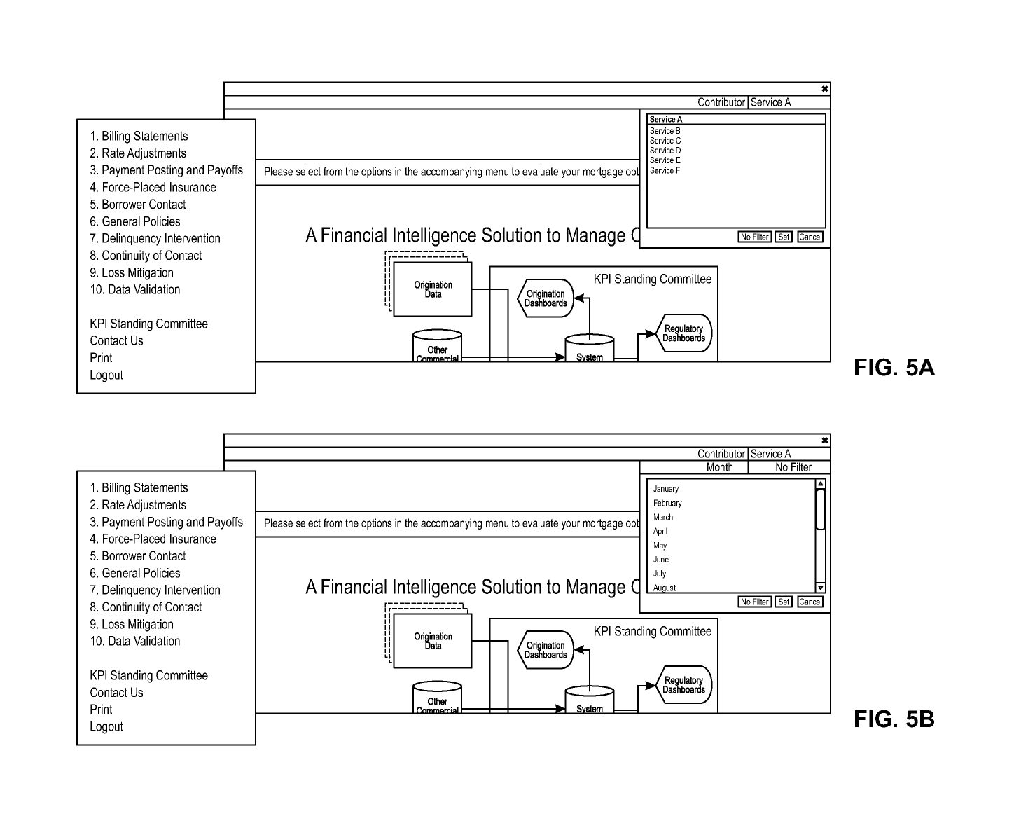

FIGS. 5A-5B depict example functional interfaces allowing data contributors 12 (e.g., mortgage companies) to provide data to the mortgage system 10. In FIG. 5A, multiple contributor datasets can be uploaded by a data contributor 12 or multiple data contributors 12 such as from a server A for servicer A, server B for servicer B, server C for servicer C, server D for servicer D, server E for servicer E, and server F for servicer F. As the data is uploaded, the data contributor 12 is tied to access credentials that limit access to the uploaded contributor data set(s) by other data contributors 12 or other users such as regulators. Each data contributor 12 can control who can observe their performance metrics and other key performance indicators (e.g., restricted to employees, clients, regulators, and other stakeholders). Data can be uploaded as multi period data sets (e.g., January, February, March, April, etc.) as shown in FIG. 5B. The contributed data enhances analysis by the mortgage system 10 and reduces risk through metric trending.

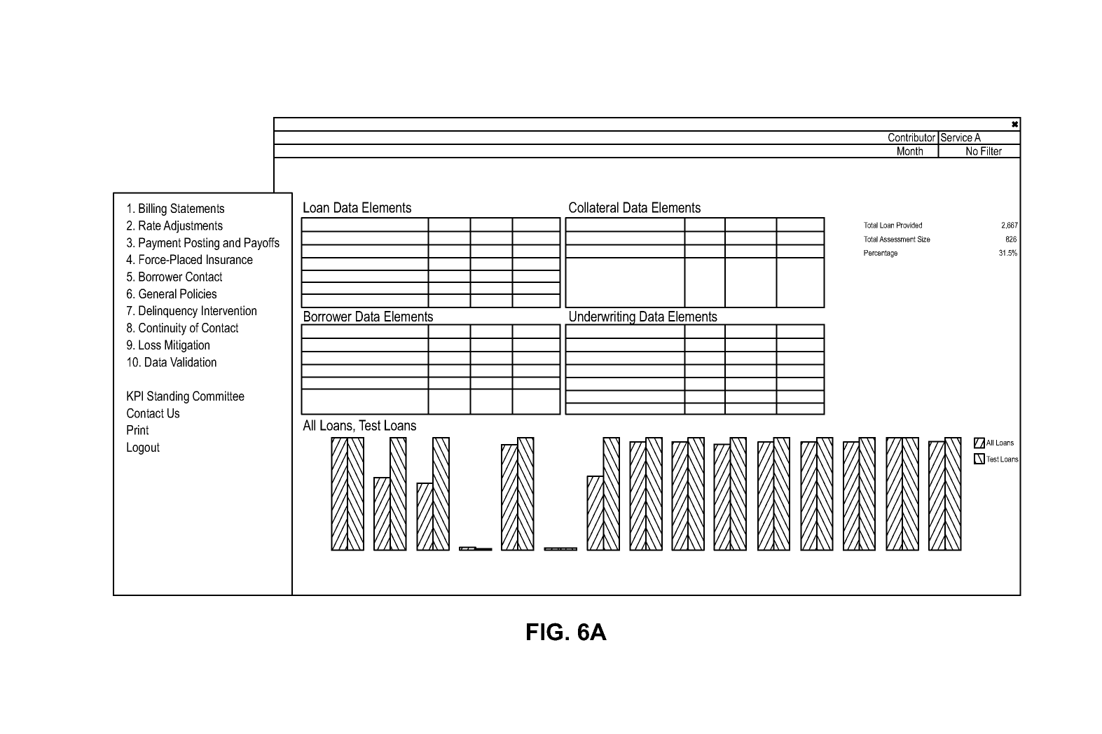

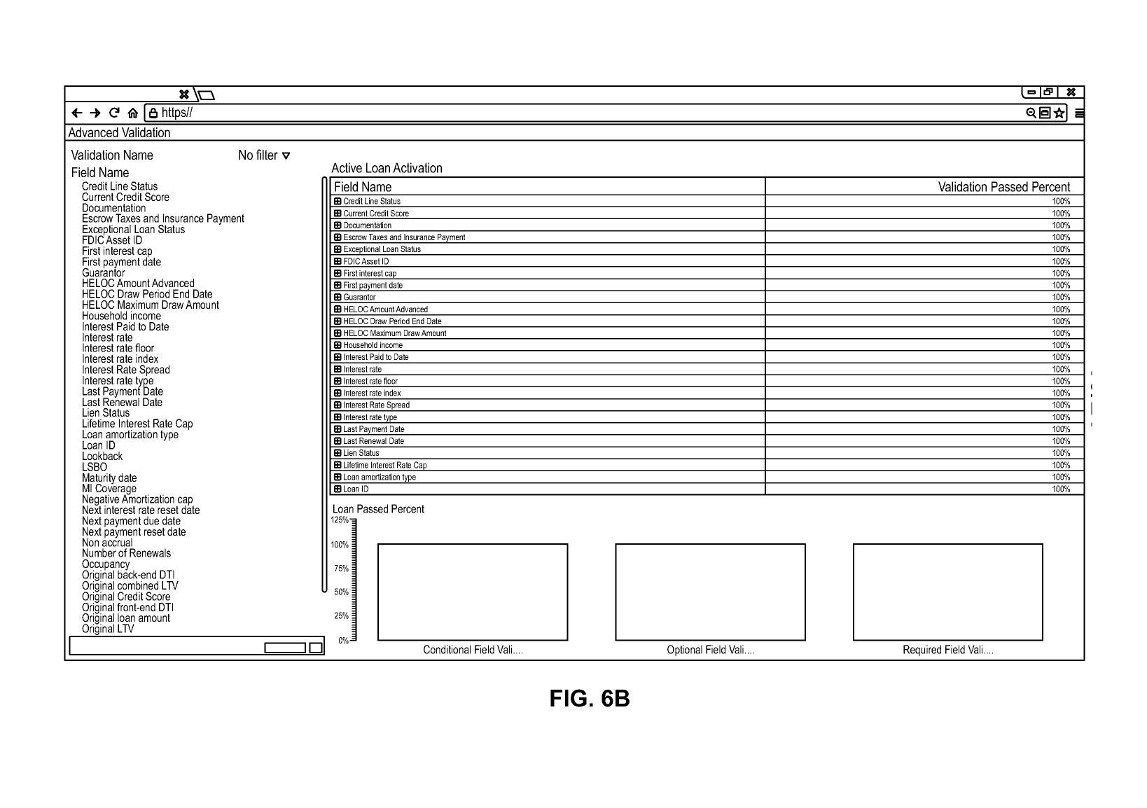

FIGS. 6A-6B depict example displays of the visual data validation functionality being utilized by the mortgage system 10. In FIG. 6A, availability rates are presented for each data element to mitigate data risk and enhance overall quality. Other functional aspects can include use of data sampling reliability factors which assist in resolving any identified data issues. For example, as shown in FIG. 6A, loan data elements, borrower data elements, collateral data elements, and underwriting data elements can be assessed with respect to various criteria in terms of “missing” and “present” information thus resulting in a specific rate percentage. Overall, the visual data validation reduces data risk and data error for data contributors 12 prior to analysis of the contributed data. In the FIG. 6B example, the mortgage system 10 can use the data validation functionality to provide data contributors 12 (e.g., mortgage companies) with the ability to visually assess the quality of the uploaded data. For example, a dimension of quality can include completeness. Each data source and component field can be presented in a drill down format based on user configurable variables. Data fields can be further categorized as user-defined field types such as Required, Optional, or Conditional as shown with bar graphs with respect to loans passed percentage as shown in FIG. 6B.

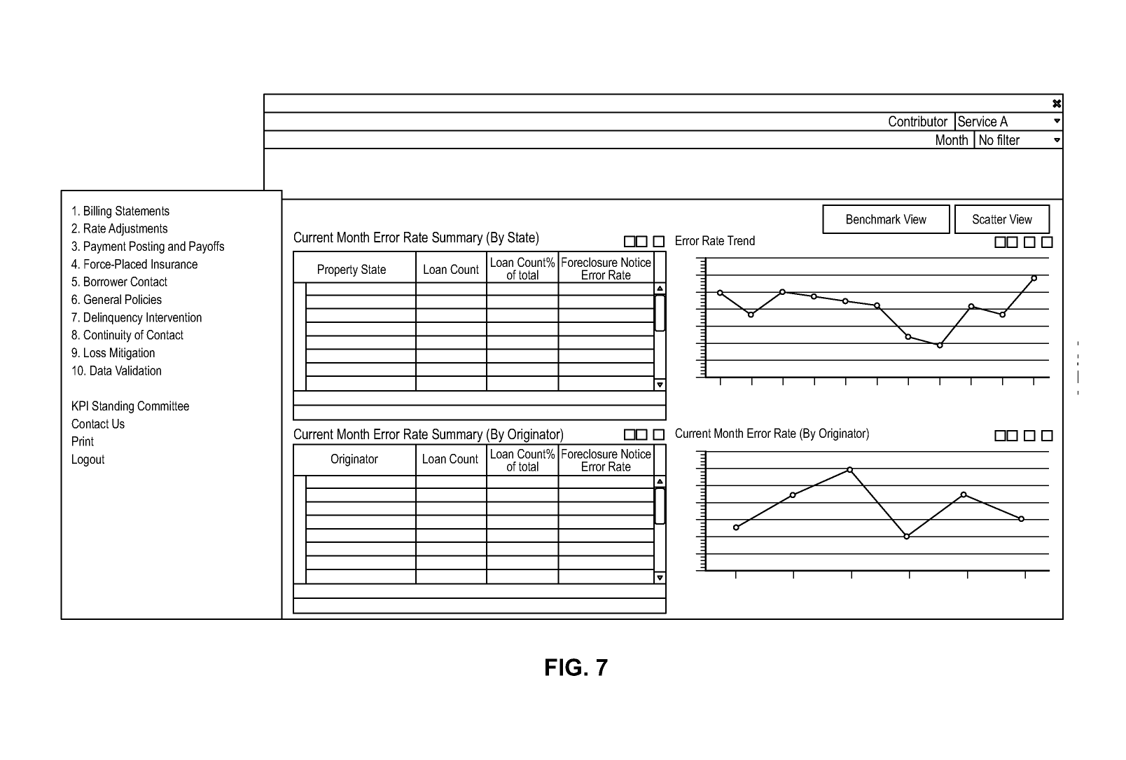

FIG. 7 depicts performance of a data contributor 12 (e.g., mortgage company) compared to other mortgage companies. In particular, this performance deals with a foreclosure notice metric. In this example, a current month error rate summary (by state) table can be compared to a current month error rate of the mortgage company (e.g., originator mortgage company). This example also provides a current month error rate graph for the originator that can be compared to an overall error rate trend graph. This type of contributor metric view allows for a mortgage company to be provided with immediate user-configurable insight into contributed data.

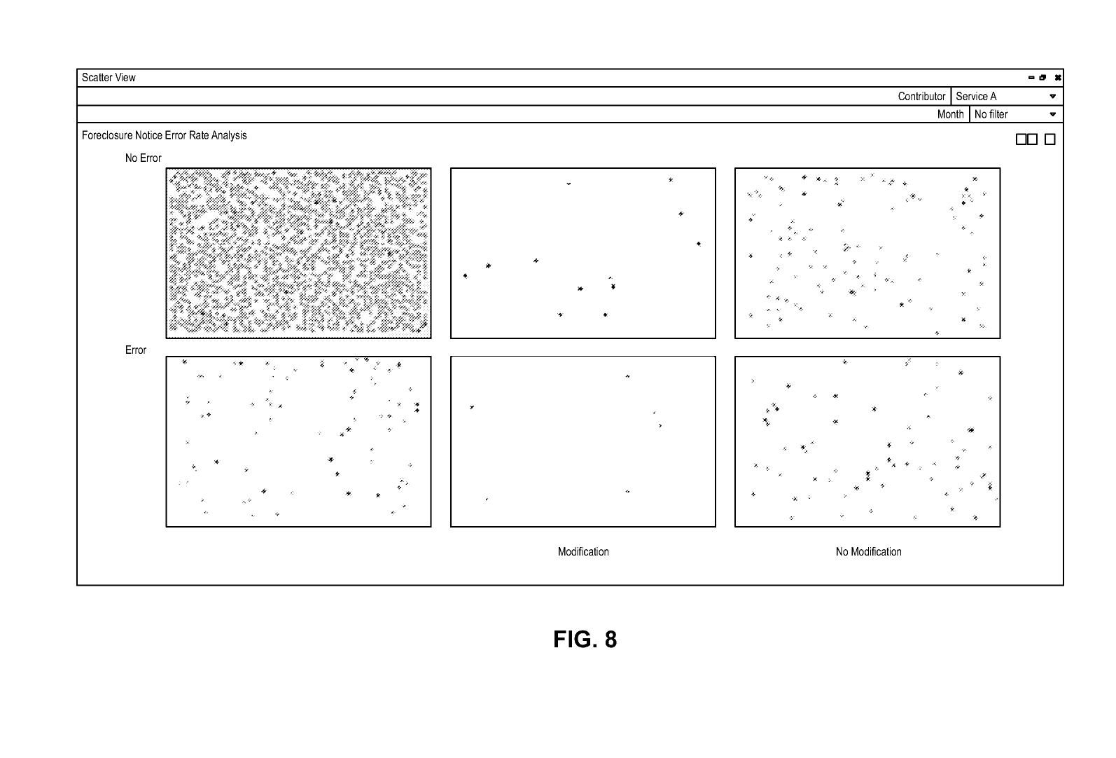

FIG. 8 depicts a scatter plot example display of performance for a data contributor 12 (e.g., mortgage company). The scatter plot or contributor scatter chart can provide user-defined insight. In this example, the scatter plot is being used to analyze a mortgage company's foreclosure notice error rate. With this type of functionality, metric performance can be evaluated in the context of other types of issues. For example, was there a foreclosure notice non-compliance event on accounts that had been reviewed or approved for modification?

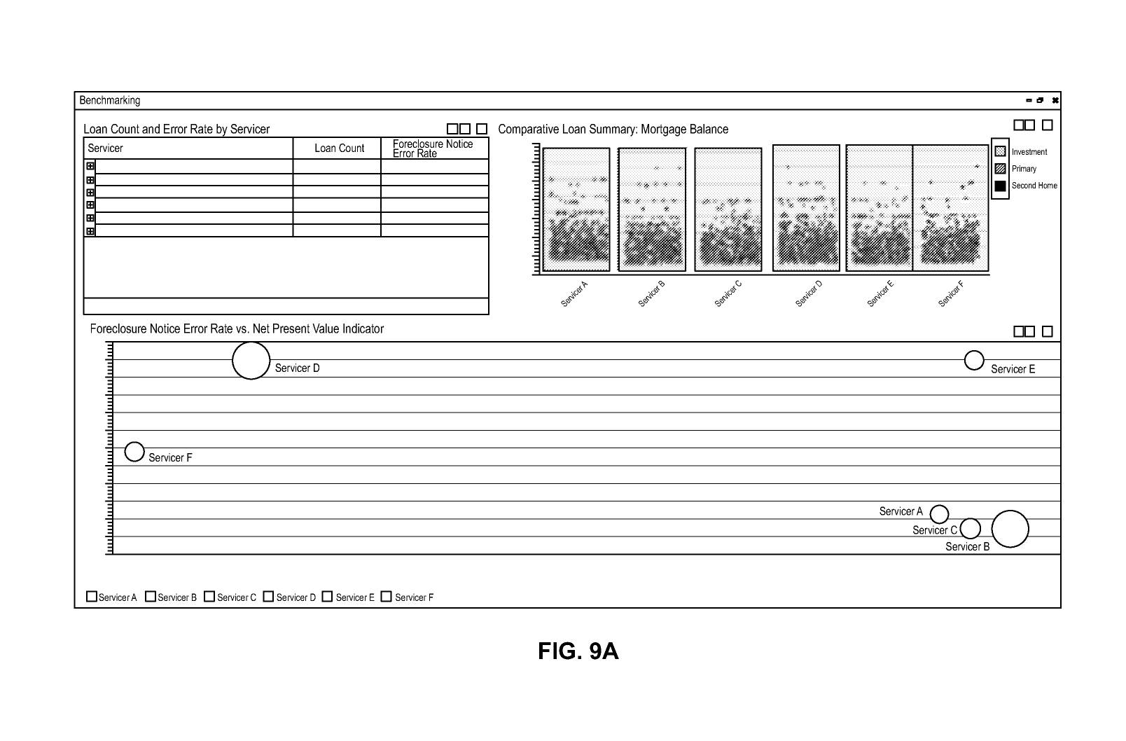

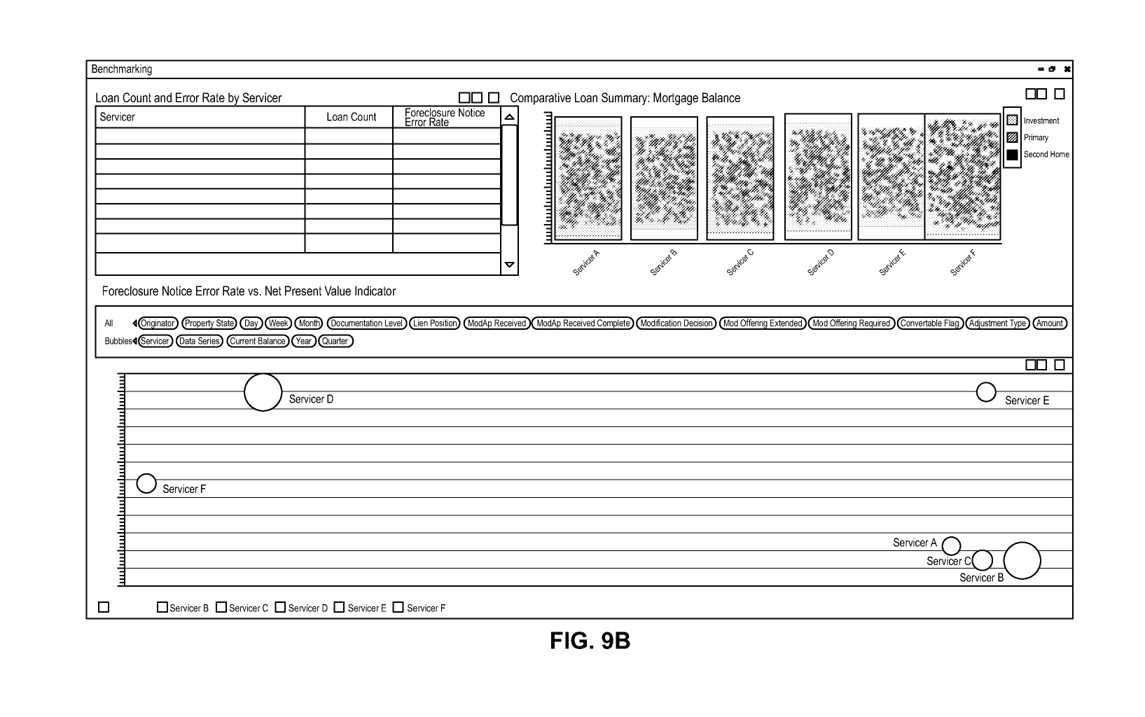

FIGS. 9A-9B depict example benchmarking views. Utilizing benchmarking views (e.g., incorporating tables, graphs, and bubble charts) enhances operating and compliance protocols for a data contributor 12 (e.g., mortgage company). As shown in FIG. 9A, the table summarizes relative size of mortgage companies (based on loan count), the scatter chart provides comparative dimensions (distinguishing whether the home was purchased as a primary home, second home, or investment), and the bubble chart provides greater context to evaluating metric results. For example, Foreclosure Notice Error Rates (x-axis of bubble chart) versus Net Present Value (y-axis of bubble chart) can be viewed where size of bubbles indicate relative loan count. FIG. 9B depicts a similar benchmarking view including additional functionality of allowing a user to drill-down for additional in-depth insight or advanced criteria (e.g., property state, lien position, modification decisions, adjustment type, etc.).

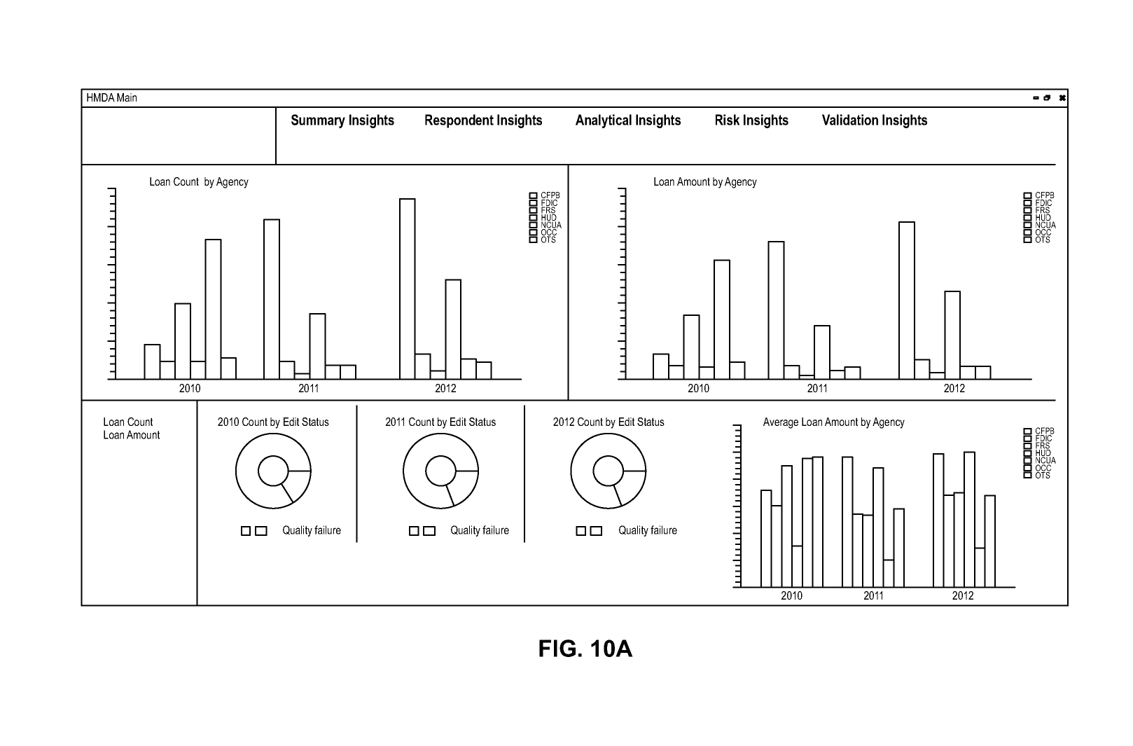

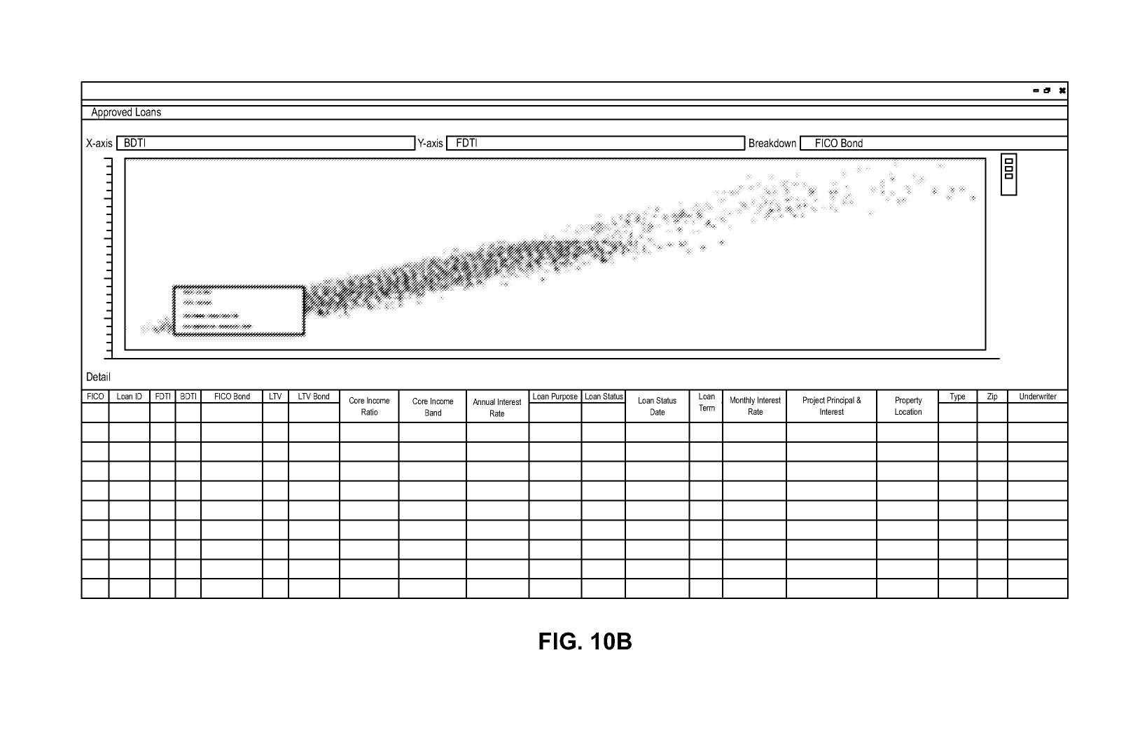

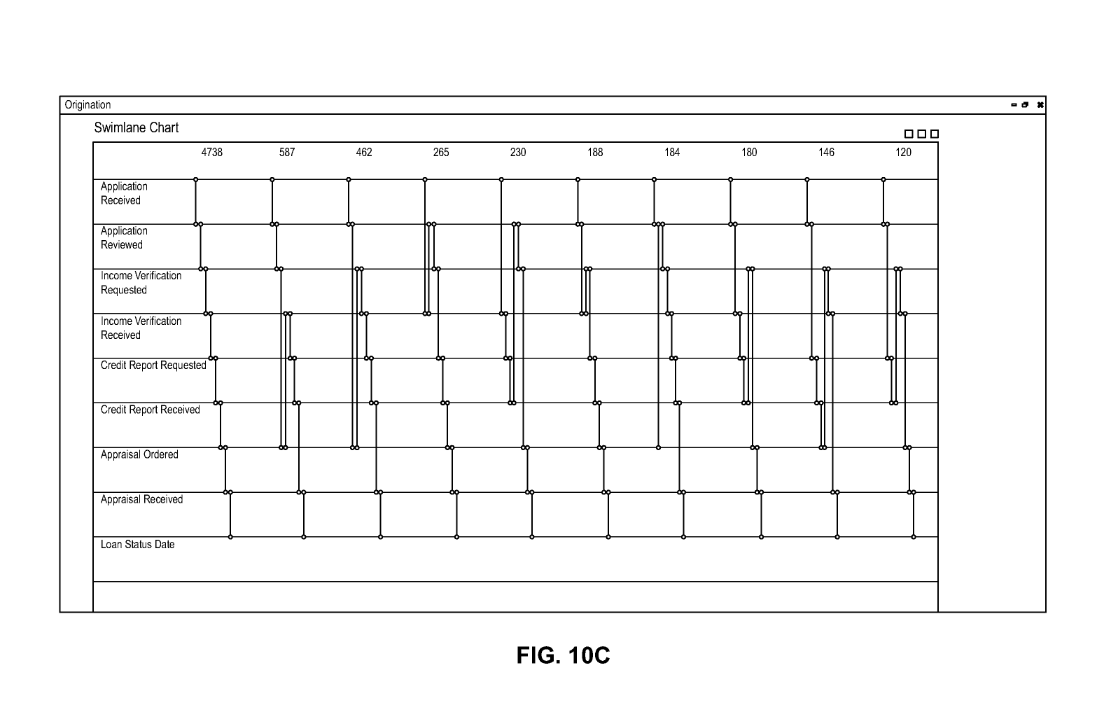

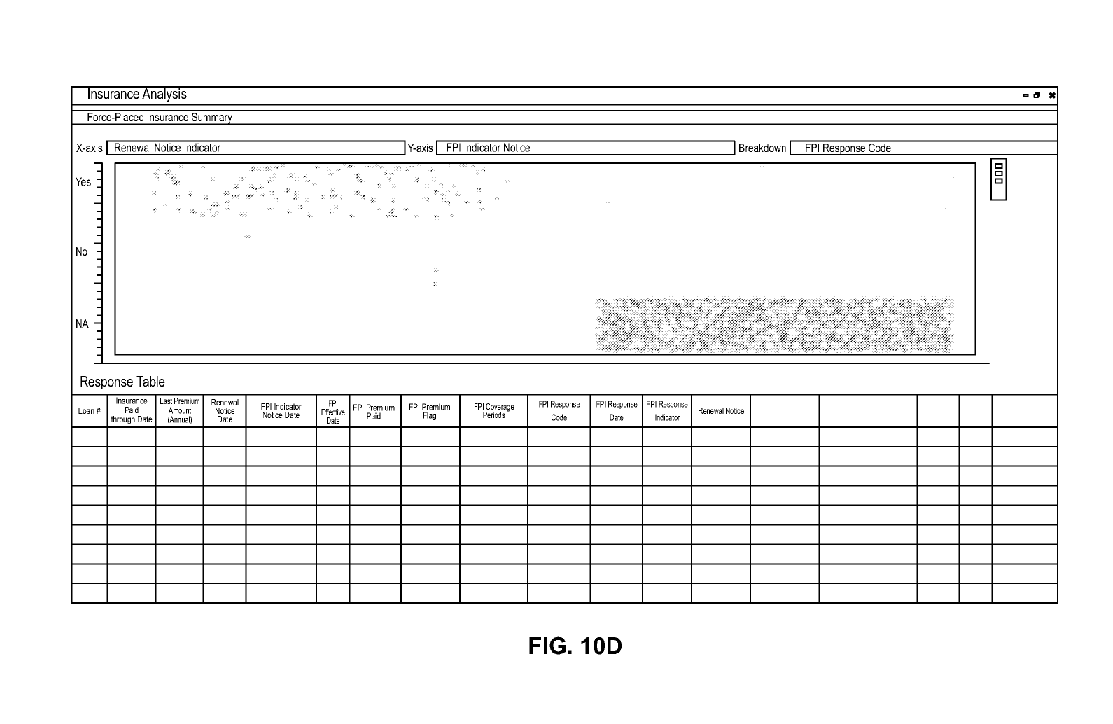

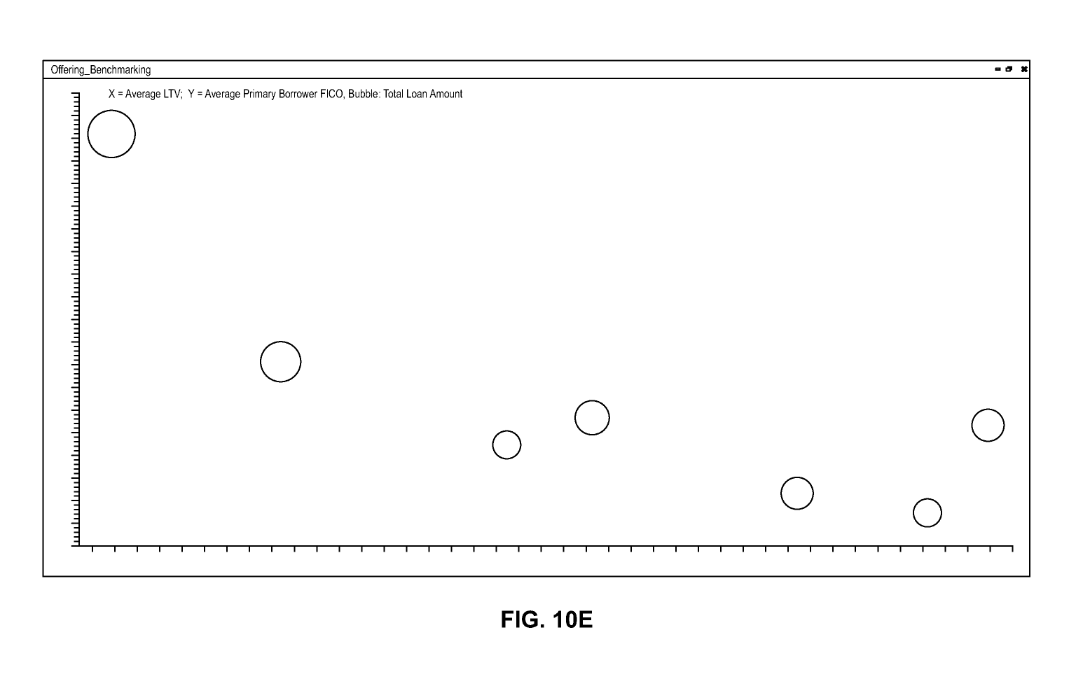

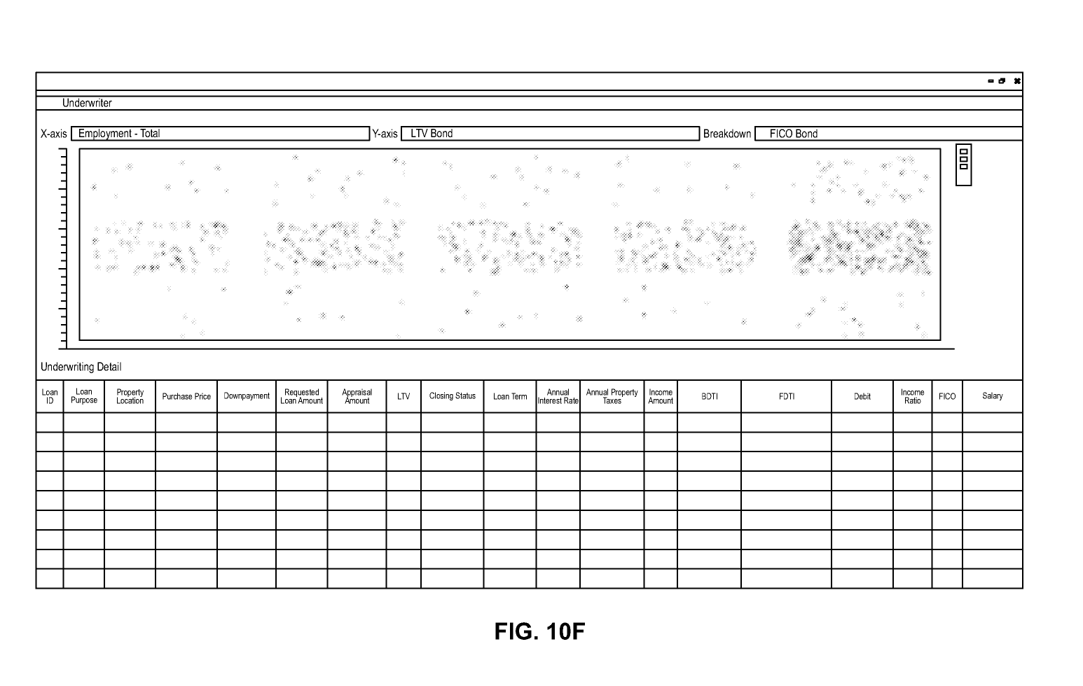

FIGS. 10A-10F depict a variety of example detail views of graphs and/or plots for use with the mortgage system 10. In FIG. 10A, a data contributor 12 (e.g., mortgage company) can view comparative government agency data such as comparing loan counts by agency, loan amounts by agency, and average loan amount by agency. For example, in the U.S., such government agencies may include CFPB, FDIS, FRS, HUD, NCUA, OCC, and OTS. In the FIG. 10B example, the mortgage system 10 can provide a detailed view for origination/approved data. In this example, the mortgage system 10 can illustrate data analysis with both a scatter chart and matrix view of loans for a mortgage company during a specified period. The scatter chart allows the mortgage company to select the “scattered dimensions” and breakout elements. In the FIG. 10C example, the mortgage system 10 can provide a detailed view for origination/business process intelligence data as a swim lane chart. The swim lane loans are displayed according to processing sequences. In the FIG. 10D example, the mortgage system 10 can provide a detailed view with respect to servicing data specifically compliance indicators. Within compliance indicators, force-placed insurance is selected to display the force-placed insurance summary of data for a data contributor 12. In the FIG. 10E example, a bubble chart is used to display secondary/origination data with respect to benchmarking. CFPB and other agency compliance standards could be used in metric. In the FIG. 10F example, a scatter plot is utilized to display Governance, Risk, and Compliance (“GRC”) with respect to underwriter data (employment total vs. LTV Band).

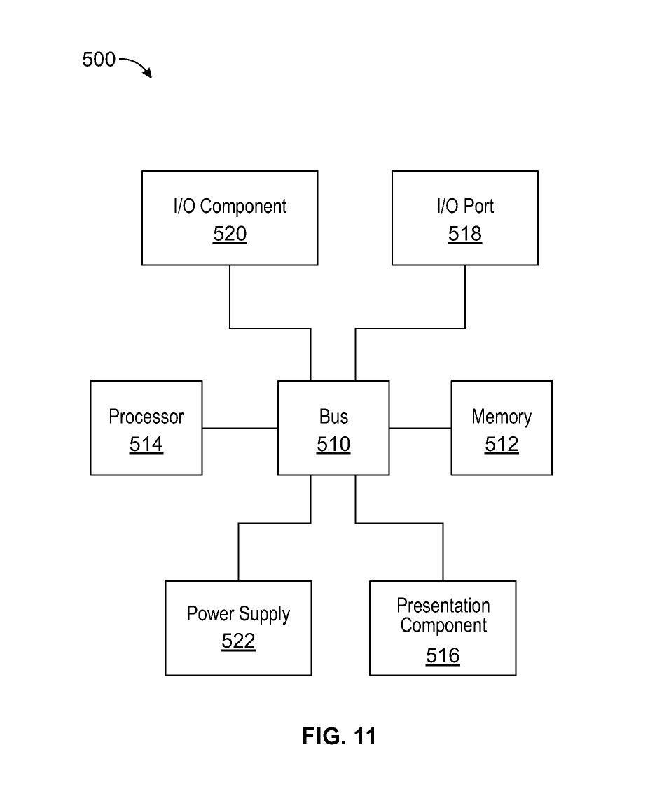

FIG. 11 illustrates an example of a computing device 500 which can provide computing or processing functionality for the mortgage system 10 and any other processing functionality described herein and utilized in the implementation of aspects of the illustrative methods and systems of the present invention. The computing device 500 is merely an illustrative example of a suitable computing environment and in no way limits the scope of the present invention. A “computing device,” as represented by FIG. 11, can include a “workstation,” a “server,” a “laptop,” a “desktop,” a “hand-held device,” a “mobile device,” a “tablet computer,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 512, one or more processors 514, one or more presentation components 516, input/output ports 518, input/output components 520, and a power supply 522. One of skill in the art will appreciate that the bus 510 can include one or more busses, such as an address bus, a data bus, or any combination thereof. One of skill in the art additionally will appreciate that, depending on the intended applications and uses of a particular embodiment, multiple components can be implemented by a single device. Similarly, in some instances, a single component can be implemented by multiple devices. As such, FIG. 11 is merely illustrative of an exemplary computing device that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 512 can include computer-storage media in the form of volatile and/or nonvolatile memory. The memory 512 can be removable, non-removable, or any combination thereof. Exemplary hardware devices are devices such as hard drives, solid-state memory, optical-disc drives, and the like. The computing device 500 can include one or more processors 514 that read data from components such as the memory 512, the various I/O components 520, etc. Presentation component(s) 516 present data indications to a user or other device. Exemplary presentation components 516 include a display device, speaker, printing component, vibrating component, etc. The I/O ports 518 can allow the computing device 500 to be logically coupled to other devices, such as I/O components 520. Some of the I/O components 520 can be built into the computing device 500. Examples of such I/O components 520 include a microphone, joystick, recording device, game pad, satellite dish, scanner, printer, wireless device, Bluetooth® device, networking device, and the like.

One of skill in the art will appreciate a wide variety of ways to modify and alter the system and method of FIGS. 1-11, as well as the various components with which it interacts. For example, the one or more computing systems can be implemented according to any number of suitable computing system structures. Furthermore, some or all of the information contained in the one or more data sources alternatively can be stored in one or more remote databases (e.g., cloud computing infrastructure such as cloud databases, virtual databases, and any other remote database).

In some embodiments, it may be desirable to implement the method and system using multiple iterations of the depicted modules, controllers, and/or other components, as would be appreciated by one of skill in the art. Furthermore, while some modules and components are depicted as included within the system, it should be understood that, in fact, any of the depicted modules alternatively can be excluded from the system and included in a different system. One of skill in the art will appreciate a variety of other ways to expand, reduce, or otherwise modify the system upon reading the present specification.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method, comprising:
in one or more computing systems:
providing a standard set of key performance indicators in the mortgage field to a group of data contributors;
receiving data from the group of data contributors;
determining one or more performance metrics over a period of time on an absolute basis, wherein the absolute basis comprises comparing data from one data contributor of the group of data contributors with its own data, and/or to stipulated standards in such a way that an absolute difference is determined based on at least one of the key performance indicators; and
determining one or more performance metrics either at a point in time or for a period of time on a relative basis, wherein the relative basis comprises comparing a set of data of the group of data contributors against a different set of data from a different group of data contributors on an anonymous and transparent basis in such a way that a relative difference is determined based on at least one of the key performance indicators; and
storing and displaying a comparison of the one or more performance metrics determined on the absolute basis and/or the relative basis.

2. The method of claim 1, wherein the step of determining one or more performance metrics on the relative basis further comprises:
benchmarking data from the group of data contributors with the different set of data from the different group of data contributors to generate benchmark data; and
identifying actions and activities by the group of data contributors based on the generated benchmark data.

3. The method of claim 2, wherein the benchmark data comprises both standard mathematical and statistical summaries and user-configurable metrics and analytics based on a body of contributed data elements.

4. The method of claim 1, further comprising validating the data received from the group of data contributors prior to steps of determining one or more performance metrics.

5. The method of claim 1, wherein displaying the comparison of the one or more determined performance metrics comprises a comparison based on compliance indicators.

6. The method of claim 1, wherein displaying the comparison of the one or more determined performance metrics comprises a comparison based on business process indicators.

7. The method of claim 1, wherein displaying the comparison of the one or more determined performance metrics comprises a comparison based on collaborative benchmarking.

8. The method of claim 1, wherein displaying the comparison of the one or more determined performance metrics comprises a comparison based on secondary market and/or securitization.

9. The method of claim 1, wherein displaying the comparison of the one or more determined performance metrics comprises a comparison based on governance, risk, and compliance protocols.

10. A computer implemented mortgage system comprising:
a first module configured to support operating and compliance metrics;
a data store configured to store a set of key performance indicators in the mortgage field related to rules and regulations by regulators and third parties;
a second module configured for data validation and related visualization protocols, wherein the second module provides assurance that a plurality of contributed data is valid and usable within the system; and
a multi-tier user access authorization module configured to allow a plurality of data contributors of the plurality of contributed data to provide information to clients, auditors, regulators, and/or authorized third parties.

11. The computer implemented system of claim 10, further comprising a third module configured to develop, test, maintain, and manage regulatory taxonomies based on both rules and regulations issued by government agencies and a group consensus.

12. The computer implemented system of claim 10, further comprising a third module configured to incorporate data from one or more data contributors of the plurality of data contributors and subject-matter experts.

13. The computer implemented system of claim 10, wherein the first module is configured to determine one or more performance metrics on an absolute basis and/or relative basis based on the plurality of contributed data.

14. The computer implemented system of claim 13, wherein the first module is configured to benchmark the plurality of contributed data from the plurality of data contributors with a different set of contributed data from a different plurality of data contributors to generate benchmark data, wherein the first module is configured to identify actions and activities by the plurality of data contributors based on the generated benchmark data.

15. The computer implemented system of claim 14, wherein the generated benchmark data comprises both standard mathematical and statistical summaries and user-configurable metrics and analytics based on a body of contributed data elements.

16. The computer implemented system of claim 10, further comprising a display module configured to display a comparison of one or more performance metrics.

17. The computer implemented system of claim 16, wherein the display of the comparison of the one or more performance metrics comprises a comparison based on compliance indicators and/or business process indicators.

18. The computer implemented system of claim 16, wherein the display of the comparison of the one or more performance metrics comprises a comparison based on collaborative benchmarking.

19. The computer implemented system of claim 16, wherein the display of the comparison of the one or more performance metrics comprises a comparison based on secondary market and/or securitization.

20. The computer implemented system of claim 16, wherein the display of the comparison of the one or more performance metrics comprises a comparison based on governance, risk, and compliance protocols.
